(19) United States
(12) Patent Application Publication
(10) Pub. No.: US 2010/0005394 A1
(43) Pub. Date: Jan. 7, 2010

(54) METHOD AND SYSTEM FOR COLLABORATIVE VIEWING

(76) Inventor: Shlomo Dubnov, San Diego, CA (US)

Correspondence Address: Shlomo Dubnov, 3767 Mississippi st., San Diego, CA, 92104, US

(21) Appl. No.: 12/497,651

(22) Filed: Jul. 4, 2009

Related U.S. Application Data
(60) Provisional application No. 61/077,885, filed on Jul. 3, 2008.

(51) Int. Cl. G06F 3/048; G06F 15/16

(52) U.S. Cl. 715/733; 709/203

(57) ABSTRACT

A method and apparatus for dynamically sharing information between viewers viewing an event, in which information is stored in a database and is being pushed from server to viewers according to a time-line. Additional information is uploaded to the server by the users, a display device associated with each user displays the main event, a billboard comprising data pushed from a server, a private area in which the user can display or manipulate data, and a shared area displaying information contributed by any of the users. The billboard data and the shared area data optionally comprise prioritized and current data which corresponds with the state and subject of the broadcast event.

### CROSS REFERENCE TO RELATED APPLICATIONS

The present application claims the benefit of the filing date of U.S. provisional patent application Ser. No. 61/077,885, filed on Jul. 3, 2008, the disclosures of which are incorporated herein by reference.

### TECHNICAL FIELD

The present disclosure relates to interaction in general, and to a method and apparatus for viewing media while collaborating with other viewers, in particular.

### BACKGROUND

Computers and computer networks are currently being used, among other purposes, for wide variety of entertainment and educational purposes.

Broadcasting and projection are common means for transferring media simultaneously to multiple viewers, and are currently performed in a variety of ways, including projecting media to viewers on a common screen, broadcasting to multiple devices such as TV sets or computers viewed by one user or a small group of users, or the like. The media types can include audio, video, presentations, live broadcasting, or any other media.

However, such broadcasting or projection does not enable the viewers to contribute data to each other, consume data from each other, participate in discussions, or the like.

Some platforms enable collaborative work, in which the product, such as a document, a presentation, a drawing, or the like, is the result of cumulative effort by all contributors.

However, such collaboration tools are intended for creating or enhancing a product. No such platform supports simultaneously viewing already available media, while exchanging or sharing data related to the media, in the form of a debate, commentary, reference to additional relevant materials, or the like.

Other platforms provide educational systems, such as web-seminars (webinars) in which a teacher provides a lecture and students may ask questions. However, the event is a live one so that a teacher can stop and relate to students' questions and comments. On the other hand, the ability of a student or even the teacher to share information online, and logically associate the information with the main event is very limited.

There is thus a need in the art for a method and apparatus for enabling multiple viewers to view media such as video, a presentation, a live broadcast or the like, while providing the viewers with the option to enrich and widen the experience, by exchanging relevant ideas and materials.

### SUMMARY

A method and system for presenting an event to a user, and enabling the user to participate in the event by receiving materials from the event manager and contributing materials to other participants, whether they are participating in the event at the same time or later. The event and all materials are stored in a repository with a time or time-range indication, so a complete timeline of the event is available.

One aspect of the disclosure is related to a method for viewing an event and sharing information related to the event in an environment comprising a server and one or more client computing platforms used by one or more users, the method comprising: broadcasting the event from the server to one or more of the client computing platforms; retrieving additional data relevant to the event from a storage device; pushing the additional data from the server to the client computing platforms; receiving user data from a user; storing the user data in a storage device associated with the event; and pushing the user data to one or more of the client computing platforms. The method can further comprise a step of displaying the event, the additional data and the user data on a display device. Within the method, the user data is optionally generated by the user in a private area displayed on the display device. Within the method, the user data stored in the storage device is optionally associated with one or more items selected from the group consisting of: absolute time; absolute time-range; time relative to the event; time-range relative to the event; location; and user privileges. The method can further comprise a step of evaluating or prioritizing the user data. Within the method, the additional data and the user data are optionally displayed to the user on different areas of a display device. Within the method, the event, the additional data and the user data are optionally displayed for each user on a personal display device. Within the method, the additional data is optionally displayed for each user on a personal display, and the event and user data are displayed on a display device viewed by at least two viewers.

Another aspect of the disclosure relates to an apparatus for viewing an event and sharing information in an environment comprising one or more servers, one or more client computing platforms, and one or more display devices, the apparatus comprising: a server application for broadcasting the event and providing additional data and shared data to the client computing platforms, the server application comprising: an application server for pushing data to the client computing platforms; director functionality components for manipulating data to be sent to the client computing platforms; and a storage connectivity component for communicating with a storage device storing the event and the additional data, wherein the one or more of the display devices displays the event and the shared data. Within the apparatus a second display device optionally displays the additional data. Within the apparatus, the display devices display the additional data, and a second display device displays the event and the data shared between viewers, and wherein the second display device is adapted to be viewed by two or more viewers. Within the apparatus, the application server optionally comprises a server-side push component for pushing data to client computing platforms; and a client management component for managing communication with the client computing platforms. Within the apparatus, the application server may further comprise a graphic user interface functions and enhancement component for presenting special effects or using plug-ins for manipulating media types. Within the apparatus the director functionality components optionally comprise: an event management component for managing the event to be broadcast; and a shared canvas management component for managing information to be shared between viewers. Within the apparatus, the shared canvas management component optionally prioritizes between data items submitted by two or more users. Within the apparatus the director functionality components may further comprise: a search and association component for searching data to be displayed to viewers, and associating the data with the event; and a billboard management component for managing information to be displayed to viewers. The apparatus can further comprise a client application comprising: a graphic user interface component for displaying the event and additional data to a user; and a communication management component for managing communication of the computing platform with the server. Within the apparatus, the client application may further comprise a data management component for managing the data displayed to the user in addition to the event. The apparatus can further comprise a storage device for storing data associated with the additional data or user data.

Yet another aspect of the disclosure relates to a computer readable storage medium containing a set of instructions for a general purpose computer, the set of instructions comprising: broadcasting an event from a server to one or more client computing platforms; retrieving additional data relevant to the event from a storage device; pushing the additional data from the server to the at client computing platforms; receiving user data from one or more users; storing the user data in a storage device associated with the event; and pushing the user data to the client computing platforms.

### BRIEF DESCRIPTION OF THE DRAWINGS

These and other inventive features, advantages, and objects will appear from the following Detailed Description when considered in connection with the accompanying drawings in which similar reference characters denote similar elements throughout the several views. The drawings provide exemplary embodiments or implementations of the disclosure and do not limit the scope of the disclosure. In the drawings:

FIG. 1 shows a schematic illustration of the architecture of a first embodiment of an apparatus for separate viewing and contributing to events, in accordance with the disclosure;

FIG. 2 shows a schematic illustration of architecture for a second embodiment of an apparatus for common viewing and contributing to events, in accordance with the disclosure;

FIG. 3 is a schematic illustration of the activities and data flow between the displayed areas, in accordance with the disclosure;

FIG. 4 is a flowchart of the main steps in a method in accordance with the disclosure; and

FIG. 5 is a block diagram of the main components in an apparatus in accordance with the disclosure.

### DETAILED DESCRIPTION

A method and apparatus for enriching the experience of, and sharing information between multiple viewers watching a media simultaneously. The media can be a video stream, a presentation, a live broadcasting, or a collection, sequence or aggregate thereof, or the like.

The apparatus comprises one or more servers and one or more clients, wherein each client is preferably a computing platform used by a user.

The users, also referred to as viewers or participants, view the presentation or event on a display device, which displays at least three distinct areas, windows, panes, or the like.

On a first area, the main story, i.e., the event, presentation, video or live broadcasting is shown. The event may be broadcast using any video streaming, document or presentation sharing, such as Quicktime, Flash, MPEG4, or any other technology.

On another area, referred to as a billboard area, additional materials sent by the event moderator, organizer, manager, administrator or another person are displayed, which may include text, links, images, audio, video in any format, or the like. The materials presented on the billboard area can be common to all viewers of the event, or personalized and adapted for a specific viewer, viewer group, or viewer type, such as students of different classes viewing the same lecture. The contents of the billboard may vary according to the progress of the main event. Thus, in some embodiments, at any particular time the billboard comprises materials and data related to the current status or subject of the event, which may then be replaced with other and more relevant materials. Therefore, in order for the viewers to always see the updated materials, push technology is used by the server, to transmit the materials to the viewers and update their billboard, without the viewers having to refresh their views in order to receive updated materials. The underlying technology can be HTTP server push, offered through Common Gateway Interface (CGI), Multipurpose Internet Mail Extensions (MINE), Web Hypertext Application Technology Working Group (WHATWG) or others, Java pushlet, long polling, or others.

The materials to be displayed to the users are optionally retrieved in accordance with a plan or a script from a database, in accordance with a timeline, such that at each point in time of the event, materials relevant to that time or time range are retrieved and pushed. The materials may be pushed to all viewers, or only to viewers meeting certain conditions, such as location, permissions, user profile or the like.

Another optional area, referred to as a private canvas, comprises materials which the user copied or dragged from the billboard, materials the user typed or selected from another application, searches and search results, or any other material, including text, images, audio, video, links or the like. Each viewer sees only the materials and content he or she chose to place on the private canvas, and thus each viewer may see a different private canvas. In some embodiments, the private canvas can be seen or accessed by the meeting or event organizer, while in other embodiments only the viewer can see the content of his or her own private canvas.

Yet another area is the shared canvas, which comprises materials provided by any viewer. The shared canvas enables a viewer to share materials with other viewers, and thus enrich the total experience of all viewers with new ideas, questions, answers, multimedia, or any other material.

The shared canvas is updated by a participant moving data into the shared canvas, for example by dragging data from the billboard or from the private canvas into the shared canvas, copying and pasting, screen scraping, or any other option. The materials are sent to the server, and then pushed to all clients, so the information is shared. It will be appreciated that the same push technology as used for the billboard area can be used for the shared canvas area. The shared canvas may be updated by the event organizer or moderator, or according to an automatic script in accordance with the main event.

In some embodiments, data shared by a viewer is automatically sent to all other viewers. In other embodiments, the data is filtered manually, automatically or semi-automatically by an automatic process or by the event organizer or another person, and only appropriate or suitable data is pushed. In some embodiments, data provided by some users may be automatically trusted and shared, while data shared by others may require validation.

All data, including the event, the data sent by the event organizer, and data shared by the users are optionally stored in a repository. Each such item is optionally stored with a time, time-range or another indicator relevant to the event, so that a full timeline of the event can be constructed.

In addition, the data, the event, or part thereof may be associated with a location. A user can thus build or receive a schedule of events, for example a schedule of lectures in a museum, wherein each lecture relates to a particular room in the museum. By moving between the locations with a mobile computing platform and optionally wireless communication, the user can view the relevant event in each room, and participate in the event by contributing materials.

Since all areas, and in particular the shared canvas area is of limited size, it may be required to prioritize the data sent by users to be shown on the billboard or on the shared canvas area, to ensure that the most relevant items are displayed, and also that the displayed information is relevant to the current subject or status of the main event, and that data that is not relevant anymore, is not displayed.

Users who are interested in particular data item displayed on the billboard or on the shared canvas area, can move, drag or copy it to their private canvas, where it will be not be removed unless they decide to remove it.

In one embodiment, the event area and the shared canvas area can be common to all viewers, for example by showing them on a large screen commonly viewed by multiple participants, wherein each participant is using a computing platform that displays the billboard and the private canvas. This arrangement can be useful, for example, in situations such as a lecture being displayed on a large screen, wherein students equipped with laptops or other mobile devices can share ideas or materials with other students without interrupting the event. This embodiment provides shared viewing of the event, with personal contribution.

In yet another embodiment, the main event can be a live or another event seen by the users, wherein only the billboard and the private canvas area are seen on the user's display device.

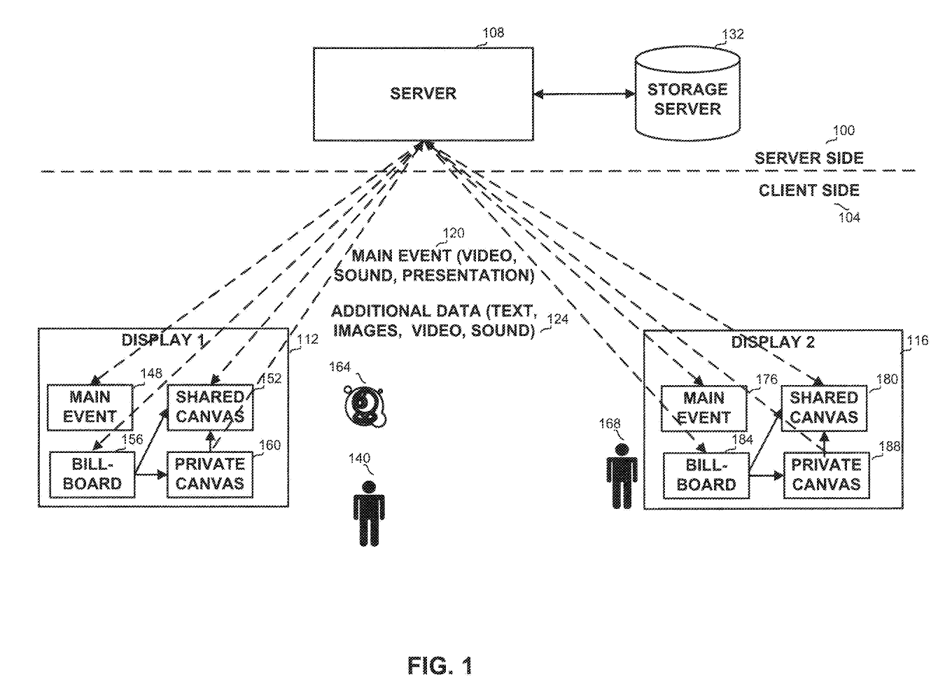

Referring now to FIG. 1, showing a schematic illustration of a first exemplary embodiment of an apparatus for shared viewing and contribution.

The apparatus comprises a server side 100 and a client side 104, wherein typically one server serves multiple clients.

Server side 100 comprises server 108 for providing the required functionalities to the clients. In some embodiments, server 108 is a collection of components executed on a computing platform, and communicating with multiple computing platform used by users and executing client applications. Server 108 uses push technologies for pushing information to clients such as computing platforms used by user 1 (140) or user 2 (168), the information comprising main event data 120 optionally containing video, audio, a presentation, live broadcasting, or the like, as well as additional data 124 optionally comprising text, images, links, video, audio, or the like.

Server 108 comprises database connectivity for communicating, i.e., retrieving and storing information in storage server 132, and client management components 118 for managing communication with the clients, and keeping track of the data received from and sent to each client, optionally including a time stamp.

Storage server 132, which may comprise a database, stores all data related to the event, including the main event, the pushed data, data contributed by the participants, and the like. Each data item is optionally associated with a time or time-range indication or other indicators. Thus, the repository comprises a full timeline of the event, with all the materials and the time at which they are to be pushed to viewers. The data may be stored whether it was provided by the event moderator or by a participant. Materials not selected by the moderator for sharing with all users may also be stored and optionally used in another occurrence of the same event or with other events. Thus, the storage contains a complete reservoir of information or applications related to the event as occurred or as scheduled to occur may be generated. In addition, storage 132 may comprise additional data not used but that may be used in the future. For each data item that is associated with a time or time-range indication, the time may be absolute or relative, i.e., indicating a time relatively to the beginning or to another point of time in the event. In other alternatives, the time may be absolute, such as a date and hour combination, repetitive. Some materials may not be associated with a time indication.

Server 108 receives data to be pushed to the clients from an event director. It will be appreciated that the event director can be a person, an application employing techniques such as artificial intelligence techniques, or a combination thereof.

Client side 104 comprises multiple clients, each being a computing platform used by one or more users, and executing user applications providing functionality to the users.

The user application can be an executable, a web page, an applet running on a web browser, or the like. User 1 (140) is using a computing platform associated with a display device 1 (112) presenting areas, windows, panes or other viewable parts including main event area 148, shared canvas area 152 showing materials contributed by other viewers, billboard area 156 showing additional materials pushed by the director of the event, and optional private canvas area 160, on which the user can insert materials of his own, including text, images, searches or the like.

Similarly, user 2 (168) is using a computing platform associated with display device 2 (116), presenting main event area 176 and shared canvas area 180, which show identical content to main event area 148 and shared canvas area 152 of display 1 (112). Display 2 (116) further presents billboard area 184 which comprises materials sent by the director to user 2 (168) and private canvas area 188 in which user 2 (168) is free to manipulate data.

On some embodiments any of the users such as user 1 (140) may use a capture device, such as a web camera 164 in order to capture images which can be posted on private canvas area 160, or even shared and posted in shared area canvas 152 and shared canvas area 180 of display 2 (116).

It will be appreciated that server 108 does not communicate directly with the display devices. Rather, server 108 communicates with the computing platforms used by user 1 (140) and user 2 (168) which in turn communicate with corresponding display devices. Thus, the dashed lines of FIG. 1 are logical and do not indicate direct data flow.

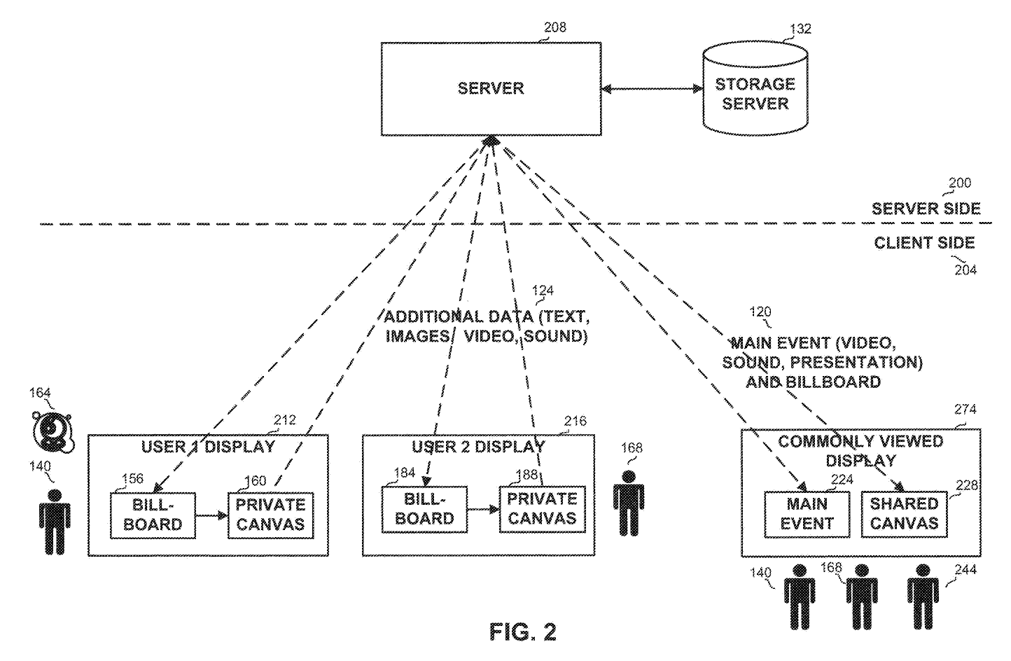

Referring now to FIG. 2, showing a schematic illustration of a second exemplary embodiment of the apparatus for shared viewing and contribution.

In the second embodiment, the content is split between a common display showing to multiple users main event area 224 and shared canvas area 228, preferably on a large screen, and individual displays, such as laptop screens or displays of mobile computing devices, showing to each user his or her own billboard and optionally private canvas Server side 200 of the second embodiment comprises server 208 which is generally similar to server 108 of FIG. 1, with the necessary changes required for supporting the split architecture.

Similarly to the first embodiment, client side 204 of the second embodiment comprises multiple clients, each associated with a display device and users by one or more users. User 1 (140) is using a computing platform associated with a display device 1 (212) displaying billboard area 156 and private canvas area 160, and user 2 (168) is using a computing platform associated with a display device 2 (116) displaying billboard area 184 and private canvas area 188. User 1 (140), user 2 (168) and possibly additional users such as user 3 (244) who does not have a personal computing platform and thus utilizes only part of the functionality, view in common a screen presenting main event area 224 and shared canvas area 228.

This embodiment is particularly useful for lectures, in which seeing the large screen provides a stronger effect, while the participants still have the option to contribute, receive, and share materials with other students or with the event organizer. Other exemplary uses of this embodiment include trade shows, museum displays, or urban digital signs where multiple visitors can see a common large screen and are able to communicate with other people present at this location.

It will be appreciated that server 208 in the second embodiment is different from server 108 of the first embodiment, since the communication with the computing platforms of the individual users such as user 1 (140) relates only to updating their billboard area 156 and receiving data from their private canvas area 160, whereas communication related with main event area 224 and shared canvas area 228 is performed and displayed only once.

It will also be appreciated that in some embodiments, the server side has one-to-one communications with the corresponding commonly viewed main event area 224 and shared canvas area 228, and in addition the server receives via separate communication channels data items from the clients using the private canvases to be posted in the shared canvas area 228.

It will be appreciated that server 208 does not communicate directly with the display devices. Rather, server 208 communicates with the computing platforms used by user 1 (140) and user 2 (168) which in turn communicate with corresponding display devices. Thus, the dashed lines of FIG. 2 are logical and do not indicate data flow.

In some embodiments, the billboard area can be general and not personalized per viewer. In such embodiments the billboard area can also be displayed on the common display device rather than on the personal display devices of each user. In such cases, users may not be able to drag information from the billboard to the private or shared canvas, but will still have all other ways to put or move data into the shared canvas.

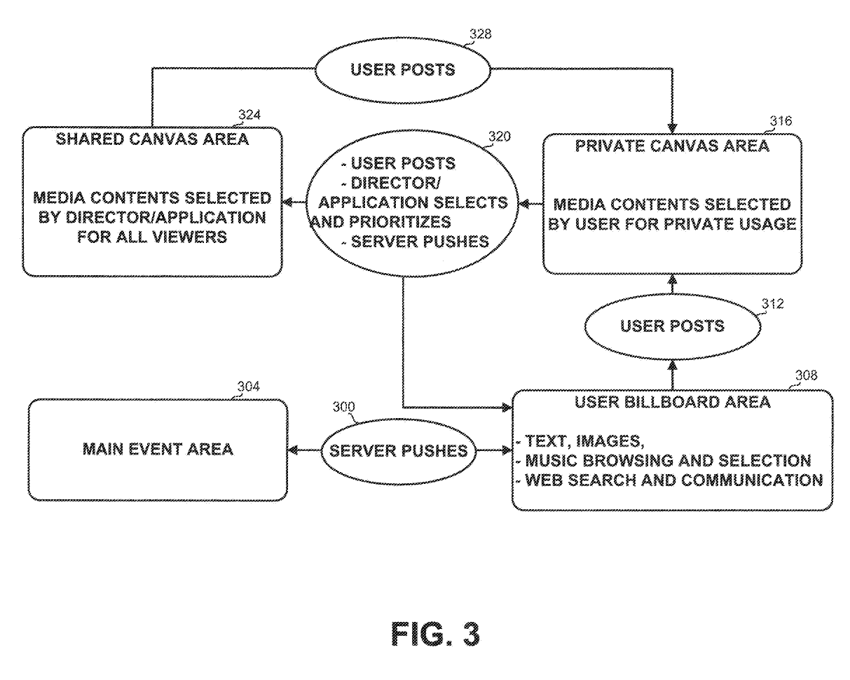

Referring now to FIG. 3, showing a chart of the information flow between the display areas shown in accordance with the system.

On step 300 the server pushes information to main event area 304 and to user billboard 308. The information pushed to main event 304 can comprise audio, video, presentations, live broadcasting or the like. The information pushed to billboard 308 is optionally user-dependent and may comprise any of the following: text, images, video, music browsing and selection, links, search terms or queries, search results or any other data item. The information may also include applications pushed to the billboard or links to external applications such as voting, ranking, text input, drawing, applying filters to images, sounds and alike. On step 312 the user fetches information from billboard 308 to his or her private canvas area 316. Fetching information from the billboard can be performed by dragging information, copying, using dedicated user interface functions, or the like.

In addition, the user can place any additional content in private canvas 316, for example by typing, drawing, copying or embedding information from any other source, performing searches, or the like.

On step 320 the user posts information from his or her private canvas to the shared canvas. Since posting involves exposing other participants to the contents, the information is sent to the server, in which it is optionally examined by a director, a manager, or an application. The director, manager or application optionally also selects from all materials posted by the participants the most appropriate, suitable, informative or otherwise valuable ones. The manager or application may also prioritize and organize the contents, so the most valuable items are best viewed. For example, the information considered to be most valuable can be presented in a larger font than other items.

In some embodiments, and due to possible performance limitations, the user cannot post certain materials from the private canvas to the shared canvas. For example, the user cannot post items containing large amounts of data, such as large images or videos. Such transfer, which includes upload of the materials from the user to the server, and from the server to all users may consume too much performance, bandwidth or time resources. In order to overcome such limitation, the user can select into the private canvas rich content from what the director or manager provides in the billboard, and then post a link to that content into the shared canvas. The server is then responsible for parsing the link, retrieving the content and posting the content into the shared canvas for all users to see.

In some embodiments, users can post data of significant volume, which will not be examined and processed by the director in real-time during the event, but may be stored, and later considered and used by the director in similar future events.

In some embodiments, one or more users may be authorized to post data to shared canvas only after some conditions are met, such as users subscribing to a service, accepting some terms, performing a purchase, or the like.

Thus, shared canvas 324 presents to all viewers dynamic media and information that was contributed by the participants, and optionally selected by the director.

It will be appreciated that users can have different privileges and trust levels, so that some users can be defined as “trustable” and materials received from such users do not have to undergo further inspections and can be posted as is. It will also be appreciated that various automatic or semi-mechanisms can be used for prioritizing the data posted by the users, such as a queue (first come first go basis), according to the relevancy of the information to the current status or subject of the main event as determined by keywords, or the like.

On step 328, the user can select and move information from the shared canvas to his private canvas, in order for the information to be available indefinitely, even when the moderator or director decides to remove it from the shared canvas. In some embodiments, fetching can be allowed subject to meeting one or more conditions, such as subscription, payment, accepting terms, or the like.

In some embodiments, the user may be able to stop the main event and concentrate only on the additional materials shown on the billboard.

Thus, the disclosed system enables a feedback loop in which content pushed by the server to the users' billboards is used to trigger activity and collaboration between participants, which eventually produces material that becomes part of the shared contents as presented on the shared canvas.

It will be appreciated that each item posted on any of the areas, can be associated with a time stamp. The time stamp is preferably relative and refers to a certain point of time in the main event. The time stamp of materials pushed by the director to the billboard can be determined a-priory so that the material is dynamically pushed to the clients at the right time. Each item can also have an expiration time. For example, in the beginning of the event, links related to the general subject may be presented on the billboard, and are later removed and replaced by other materials. Thus, the information presented on the billboard and on the shared canvas is dynamically updated so that it is relevant to the current state or subject of the event.

In some embodiments, multiple events may take place simultaneously, at partially overlapping times, or at different times, in the same or in different physical or virtual locations. The same server may handle multiple events. In such embodiments, additional information may be associated with each item, such as location of the event. It may also be possible to transfer partial information between events, such as participant names, chat, or any other data across the different events.

For example, a user visiting a tradeshow, a conference, a museum, an urban tour or any other event can receive a schedule indicating which event is available at which time and location, and move from one event to another. With or without receiving such schedule, the user can move between physical or virtual locations and participate in one or more events. In each such event, the user can provide feedback which can later be seen by later participants or viewer of the event. The user can also have a “playlist” of the events he wishes to participate in, so that the system switches from one event to the other automatically, or opens multiple simultaneous events.

For example, a user carrying a computing platform such as a laptop or a handheld device while visiting a museum, is moving between rooms. In each room, a server associated with the museum communicates with the user's computing platform and displays on a display device of the user's computing platform an event, such as a video, explaining the exhibition in the room, as well as additional materials such as comments, suggested reading, or the like provided by the museum, and data contributed by visitors. The user can provide content of his own to be shared with other visitors in the room, whether the visitors are currently visiting the room or for future visitors. When the user moves to another room, he receives materials relevant to the other rooms.

Alternatively, a public display device presents the explanation and optionally the data contributed b the visitors to all visitors within the room, wherein each visitor receives the additional data to his own computing platform.

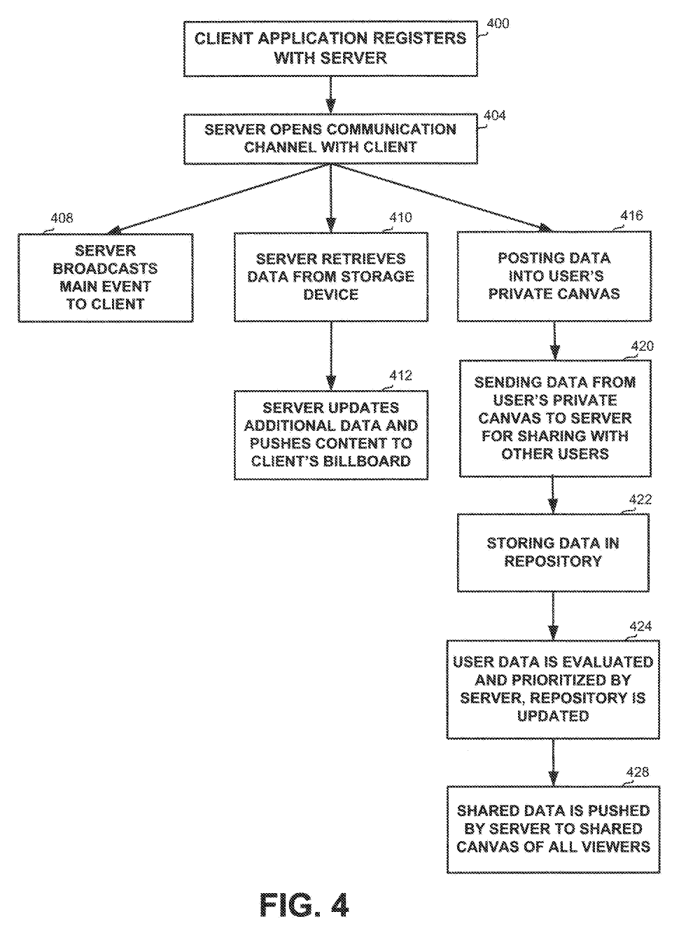

Referring now to FIG. 4, showing a flowchart of the main steps in an implementation of a shared viewing and collaboration method.

On step 400, one or more clients are registered with a server providing an event, such as a presentation, a live broadcast, an audio stream or the like. The registration can be open to any client, or depend upon receiving an invitation from the server.

Each client is optionally associated with a set comprising one or more permissions. The permissions may relate to the level of materials to be displayed to the client, the trust level assigned to materials posted by the client, or the like. The permissions are communicated between the client and the server during registration.

On step 404 the server opens a communication channel with each client. Preferably, the communication channel remains opens throughout the event, so that the server can push content dynamically and update the client, without waiting for the client to send a request to the server.

On step 408, the server transmits the main event data, such as video, audio, presentation, live broadcasting, or the like to the client, using any media streaming technology. Streaming continues throughout the event, although it may be paused for periods of time. The main event can be predetermined or live, but its content is determined by the director or manager of the event, and not by the participants. The participants can try and influence the director by posting requests for data on the shared canvas, but the content is eventually at the discretion of the manager.

It will be appreciated that if the event is managed by an automatic device such as an artificial intelligence application, the participants may determine or influence the contents of the shared canvas without human intervention.

On step 410, the server retrieves data from the storage device, according to relevant parameters, such as an absolute or relative time within the event, time-range within the event, location at which the event is occurring, viewer privileges or the like.

On step 412, the server updates the additional data to be displayed on the client's billboard. The data is optionally updated so that it matches the current state or subject of the main event, and may therefore be dynamic and synchronized with the progress of the main event being broadcast. The data is optionally personalized or customized per client, and continuously pushed to the clients. The data is optionally retrieved from an associated database, or from any other source.

The data is retrieved from the materials repository such as storage server 132 of FIG. 1, which stores all materials relevant to the event. The additional data may be retrieved according to a script generated by the event moderator, or by an automatic process.

On step 416 data is posted by a user into his private canvas area, initiated by the user fetching data from the billboard to the private canvas area, typing data, dragging or pasting data from any source or otherwise generating data, for example by searching for terms appearing on the billboard.

On step 420, data from the user's private canvas is received by the server, for sharing with other users by being posted in the shared canvas of all users.

Optionally, some or all users may be allowed to drag some or all data directly from the billboard to the shared canvas. Such situation may occur, for example, when the event manager sends some pictures or other data to a particular participant to choose from, and the selected data is posted into the shared canvas for all users.

On step 422 the data is stored within the storage device, so it can later be retrieved and used for sharing with future viewers of the events. The data is optionally stored with an absolute or relative time or time-range indication, wherein relative time or time-range relates to the event, such as “ten minutes after the event starts”.

On step 424, the data is evaluated and prioritized by the event manager, director, or another person. Alternatively, the data is evaluated and prioritized by an automatic process, which may be based among other things on user privileges, user accumulated credibility, predetermined rules, match and relevancy of the posted material to the main event, or other factors. The process may also be semi-automatic, wherein an automated process selects the content to be posted, based for example on predetermined rules, wherein the director or manager approves or enhances. The data is prioritized and updated, so that materials which become less relevant as the main event proceeds are replaced by more relevant ones.

On step 428, the shared data as determined on step 424 is pushed to the users' computing platforms, to be displayed on all users' shared canvas areas. However, in some embodiments, the data is displayed only on the shared canvases of qualified users, such as users who met authorization, payment, location-related terms, or others.

Each piece of data received from a user or posted on the billboard or the shared canvas is optionally associated with a time stamp which is preferably relative to the time of the main event. Relative to the time of the main event relates not only to the start time, but also to the progress of the event, if the event is live or if the event was paused one or more times. The event may also be associated with an expiry time. An event or data associated with an event may also be associated with a physical or virtual location, indicating for example the event identification, URL address, or the like. The events, as well as the time stamp, location and expiry time are stored in a storage device associated with the system, such as storage server 112 of FIG. 1. The events and time and optionally place indications constitute a timeline or a track associated with the event, with a particular participant in an event, or a combination thereof.

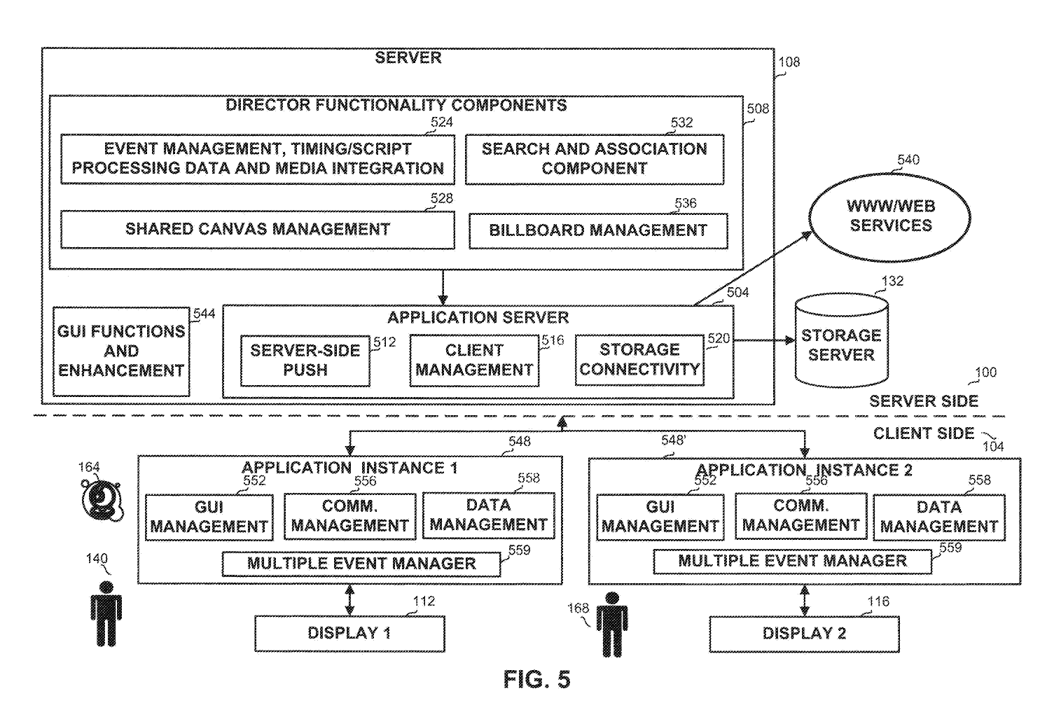

Referring now to FIG. 5, showing a schematic illustration of an exemplary embodiment of an apparatus for shared viewing and contribution to an event.

As detailed in association with FIG. 1 and FIG. 2 above, the apparatus comprises server side 100 and client side 104. Server side 100 comprises a server 108 for providing the required functionalities to the clients. Server 108 comprises an application server 504, director functionality components 508 and optional GUI functions and enhancement component 544. Application server 504 comprises server-side push components 512 for pushing information to the clients. Using the push technology, the users' displays update as the available content updates, without requiring the users to refresh their views. The pushed information comprises the main event data which may contain video, audio, a presentation, live broadcasting, or the like, as well as additional data optionally comprising text, images, links, video, audio, or the like.

It will be appreciated that the main event and the additional data may be pushed using different technologies. However, the main event, the billboard area and the shared canvas update without the user having to refresh the view.

The additional data is displayed on the user's billboard or on all users' shared canvas.

Application server 504 further comprises storage connectivity components 520 for communicating, i.e., retrieving and storing information in storage server 132, and client management components 516 for managing communication with the clients, and keeping track of the data received from and sent to each client. Each data sent or received from a client is optionally associated with a time stamp or expiry time.

It will be appreciated that client management components 516 differ between the disclosed configurations. In separate viewing configuration, as shown in FIG. 1 above, the server manages the main event area, billboard area and shared canvas area for each user. In common viewing configuration, as shown in FIG. 2 above, the server manages the main event area and the shared canvas area just once for all viewers, and manages the billboard area separately for each user.

Application server 504 also communicates with www/web services provider 540 for consuming web services, such as voting, poles, ranking, geographic information applications, shared graphics or others.

Application server 504 receives data to be pushed to clients from an event director using director functions 508. It will be appreciated that the event director can be a person, an application employing techniques such as artificial intelligence techniques, rule based techniques, or others, or a combination of automatic and manual processes.

Director functions 508 include but are not limited to event management components 524, which are also used for handling the timing, location and script management, and data and media integration for integrating predetermined additional data with the main event.

Director functions 508 further include shared canvas management components 528 for selecting, prioritizing, and otherwise manipulating the materials posted by the users on the shared canvas. The materials are prioritized so that only the most relevant ones are displayed, in order to comply with the limited available display area. Further, the relevancy of each posted data item is determined time and location-wise so that irrelevant materials are removed while new relevant materials are displayed instead.

Director functions 508 further include optional search and association components 532 operative in searching data to be displayed on the billboard, and associating the data with the main event.

Director functions 508 further include billboard management components 536 for searching, filtering and otherwise manipulating materials to be displayed on the users' billboard area.

Server 108 optionally comprises GUI functions and enhancement component 544, for supporting the presentations of data items, such as special effects, plug-ins for new types of media, or the like.

Client side 104 comprises multiple instances of a user application, each instance executed by a computing platform used by one or more users, the applications providing the user with the functionality of viewing and contributing to an event. Each computing platform is associated with a display showing the areas detailed in association with FIG. 1 or FIG. 2 above. The user application can be an executable, a web page, an applet running on a web browser, or the like. User 1 (140) is using application instance 1 (548) executed on a computing platform (not shown), which displays the main event, the billboard, the private canvas and the shared canvas on display 1 (112) associated with the computing platform.

Similarly, user 2 (168) is using application instance 2 (548′), executed on a computing platform (not shown), and displaying the areas or panes on display 2 (116).

In some embodiments, user 1 (140) or user 2 (168) may use a capture device, such as a web camera 164 in order to capture images which can be posted on the private canvas area, or even shared and posted on the shared canvas area displayed to all users.

The user application supports for each user the display and enabled operations. The operations may include but are not limited to: placing data on the private canvas; dragging data from the billboard to the private canvas; dragging data from the private canvas to the shared canvas, which causes the transfer of the data to the server, and only if determined to be appropriate and relevant it is presented in the shared canvas, saving data available during the viewing session in persistent storage, or other operations.

In some embodiments, the user application comprises a GUI management component 552 for displaying information on the display and receiving commands from the user. Each application instance also comprises a communication management component 556 for handling communication, i.e. sending and receiving data to and from the server, or with other entities, such as other application instances in some embodiments. Each application instance comprises also a data management component 558 for managing the data the user receives or submits to the system, storing and retrieving data, or the like.

Each application instance may also comprise a multiple-event manager 559, for managing the system for viewing multiple events optionally occurring at different times or locations. Multiple-event manager 559 handles scheduling the events, managing a play-list of events for a user. In some embodiments, the server application may also comprise a Multiple-event manager component for delivering multiple events, whether simultaneously, partly-simultaneously or at different times or locations. The apparatus of FIG. 5 corresponds to the architecture shown in FIG. 1 above. In order to use the architecture of FIG. 2, the same division to components may be used, however some changes may have to be introduced to some of the components, or to the connection and communication between them. In such embodiments, application instance 1 (548) and display 1 (112) are responsible for displaying only the billboard area and private canvas area to user 1, wherein application instance 2 (548′) and display 2 (116) are responsible for displaying the event itself and the area and shared canvas area to multiple viewers.

Application server 504, director functions components 508 and GUI functions and enhancement components 544, are all executed by one or more computing platforms. Similarly, each of application instance 1 (548) and application instance 2 (548′) is executed by a computing platform.

Each computing platform can be a personal computer, a mainframe computer, a server, a mobile device such as a personal digital assistant (PDA), or any other type of computing platform provisioned with a memory device, a CPU or microprocessor device, and several I/O ports. Alternatively, any of the computing platforms can be implemented as firmware ported for a specific processor such as digital signal processor (DSP) or microcontrollers, or can be implemented as hardware or configurable hardware such as field programmable gate array (FPGA) or application specific integrated circuit (ASIC).

The applications and components are implemented as interrelated sets of computer instructions, programmed in any programming language such as Java, C++, C#, or others, and developed under any development environment. The applications can be implemented as one or more web services, as installed or deployed applications, or the like.

Storage 132 can be implemented as one or more mass storage devices, for example an optical storage device such as a CD, a DVD, or a laser disk; a magnetic storage device such as a tape or a hard disk; a semiconductor storage device such as Flash device, memory stick, or the like.

It will be appreciated that the communication between server 108 and the computing platforms used by the users can use any wired or wireless communication media, such as the Internet, Intra-net, a local area network, a wide area network, Radio Frequency, telephone network, voice over IP and the like, employing commonly used protocols such as HTTP, TCP, IP, IPTV or derivatives thereof.

The disclosure provides a method and apparatus for shared viewing of an event, and dynamic collaboration of content related to the event. The disclosure provides a hybrid approach between collaboration aimed at producing a product, and passive viewing of the event. The viewers contribute data which is shared with other users. The data is updated and relayed to the viewers using push technology, so that the viewers receive current information which is relevant to the state or status of the main event.

It will be appreciated that multiple modifications and variations can be introduced to the apparatus and method. For example, any of the areas, and in particular the billboard which comprises materials pushed by the director or organizer of the event to the viewers, can be continuous or split into multiple areas. Thus, the billboard can comprise a progress bar indicating the progress of the event optionally placed at the bottom of the display, an information bar optionally placed at the top of the display, a text area, an image or view area, a toolbar, or the like.

In another embodiment, the private canvas can be distributed into two or more areas, wherein in one area the user can perform operations, such as searches, calculations, or the like, and the other area presents the results of these operations.

It will also be appreciated that the billboard and the private canvas can be combined into one area, from which materials will not be removed as the event evolves. Rather, all materials, whether placed there by the event organizer or the participant will remain available throughout the event and possibly even after the event ends.

The disclosed method and apparatus can be used for additional applications. For example, viewers of a film can receive coupons to their mobile devices for a nearby restaurant valid for a predetermined period of time after the movie. The viewers can share information with other viewers, such as forwarding the coupons or recommending the restaurant.

Similarly, people attending a concert can receive coupons for buying the disk of the performer, or the like.

It will be appreciated that any of the areas displayed on the display device may be associated with additional functionality. For example, the private canvas can be equipped with chat capabilities, so that the user can chat with other viewers of the event. The user can then share parts of the chat session with the all viewers by posting it to the shared canvas.

In another embodiment, data mining can be applied on the users' actions during active viewing, data manipulation or data posting. The complete timeline of the event may be retrieved, viewed, or examined, including what materials were shared by which participant, on what time, and what time or time-range of the event the material relates to. This enables full tracking or reconstruction of an event, including reconstruction of the discussions, comments, voting or the like. This may encourage further discussions. Thus, the event may be constructed incrementally in a number of phases occurring at different times, wherein in each phase the participants can see the feedback provided by previous participants, and provide feedback based on previous participants' materials. Using these options, a participant can view an event in his free time, provide information associated with particular time, time-range, location or another characteristics, so that other viewer can see it at a later time.

Further data that may be presented on the billboard or on the shared canvas is a list of all viewers who are participating in the event. The list may include other viewers currently participating in the event, or current and previous viewers. Such list can promote further interactions between users and increase the usability and attractiveness of the event. It will be appreciated by a person skilled in the art that the disclosed apparatus is exemplary only and that multiple other implementations can be designed without deviating from the disclosure. It will be further appreciated that multiple other components can be used. The components of the apparatus can be implemented using any proprietary, commercial or third party products.

While preferred embodiments and particular applications have been described, it is apparent to those skilled in the art that many other modifications and applications are possible without departing from the inventive concepts herein. It is therefore to be understood that within the scope of the following claims, this disclosure may be practiced in different manners than as specifically described, and is not to be restricted except in the spirit of the appended claims. While the disclosure has been described with reference to exemplary embodiments, it will be understood by those skilled in the art that various changes may be made and equivalents may be substituted for elements or steps thereof without departing from the scope of the disclosure. Therefore, it is intended that the disclosed subject matter not be limited to the particular embodiments disclosed for carrying out this disclosure, but only by the claims that follow.

What is claimed is:

1. A method for viewing an event and sharing information related to the event in an environment comprising a server and at least one client computing platform used by a user, the method comprising:
broadcasting the event from the server to the at least one client computing platform;
retrieving additional data relevant to the event from a storage device;
pushing the additional data from the server to the at least one client computing platform;
receiving user data from at least one user;
storing the user data in a storage device associated with the event; and
pushing the user data to the at least one client computing platform.

2. The method of claim 1 further comprising a step of displaying the event, the additional data and the user data on a display device.

3. The method of claim 1 wherein the user data is generated by the user in a private area displayed on the display device.

4. The method of claim 1 wherein the user data stored in the storage device is associated with at least one item selected from the group consisting of: absolute time; absolute time-range; time relative to the event; time-range relative to the event; location; and user privileges.

5. The method of claim 1 further comprising a step of evaluating or prioritizing the user data.

6. The method of claim 1 wherein the additional data and the user data are displayed to the user on different areas of a display device.

7. The method of claim 1 wherein the event, the additional data and the user data are displayed for each user on a personal display device.

8. The method of claim 1 wherein the additional data is displayed for each user on a personal display, and the event and user data are displayed on a display device viewed by at least two viewers.

9. An apparatus for viewing an event and sharing information in an environment comprising at least one server, at least one client computing platform, and at least one display device, the apparatus comprising:
a server application for broadcasting the event and providing additional data and shared data to the at least one client computing platform, the server application comprising:
an application server for pushing data to at least one client computing platform;
director functionality components for manipulating data to be sent to the at least one client computing platform; and
a storage connectivity component for communicating with a storage device storing the event and the additional data,
wherein the at least one display device displays the event and the shared data.

10. The apparatus of claim 9 wherein a second display device displays the additional data.

11. The apparatus of claim 9 wherein the at least one display device displays the additional data, and a second display device displays the event and the data shared between viewers, and wherein the second display device is adapted to be viewed by at least two viewers.

12. The apparatus of claim 9 wherein the application server comprises:
a server-side push component for pushing data to client computing platforms; and
a client management component for managing communication with the at least one client computing platform.

13. The apparatus of claim 9 wherein the application server further comprises a graphic user interface functions and enhancement component for presenting special effects or using plug-ins for manipulating media types.

14. The apparatus of claim 9 wherein the director functionality components comprise:
an event management component for managing the event to be broadcast; and
a shared canvas management component for managing information to be shared between viewers.

15. The apparatus of claim 14 wherein the shared canvas management component prioritizes between data items submitted by at least two users.

16. The apparatus of claim 9 wherein the director functionality components further comprise:
a search and association component for searching data to be displayed to viewers, and associating the data with the event; and
a billboard management component for managing information to be displayed to viewers.

17. The apparatus of claim 9 further comprising a client application comprising:
a graphic user interface component for displaying the event and additional data to a user; and
a communication management component for managing communication of the computing platform with the server.

18. The apparatus of claim 17 wherein the client application further comprises a data management component for managing the data displayed to the user in addition to the event.

19. The apparatus of claim 9 further comprising a storage device for storing data associated with the additional data or user data.

20. A tangible computer readable storage medium containing a set of instructions for a general purpose computer, the set of instructions comprising:
broadcasting an event from a server to at least one client computing platform;
retrieving additional data relevant to the event from a storage device;
pushing the additional data from the server to the at least one client computing platform;
receiving user data from at least one user;
storing the user data in a storage device associated with the event; and
pushing the user data to the at least one client computing platform.
